(19) United States
(12) Patent Application Publication
(10) Pub. No.: US 2026/0115695 A1
(43) Pub. Date: Apr. 30, 2026

(54) METHOD FOR PREPARING PLATINUM-BASED ALLOY CATALYST

(71) Applicants: HYUNDAI MOTOR COMPANY, Seoul (KR); KIA CORPORATION, Seoul (KR)

(72) Inventor: Woo Ram Kang, Hwaseong-si (KR)

(73) Assignees: HYUNDAI MOTOR COMPANY, Seoul (KR); KIA CORPORATION, Seoul (KR)

(21) Appl. No.: 19/190,174

(22) Filed: Apr. 25, 2025

(30) Foreign Application Priority Data
Oct. 29, 2024 (KR) 10-2024-0150078

(51) Int. Cl. B01J 23/42; B01J 21/18; B01J 37/08; B01J 37/16

(52) U.S. Cl. CPC B01J 23/42; B01J 21/18; B01J 37/088; B01J 37/16

(57) ABSTRACT

Disclosed is a method for preparing a platinum-based alloy catalyst using a solution combustion synthesis method, as characterized in that a metal which forms an alloy together with platinum is first loaded on a support and then platinum is loaded thereon.

### CROSS-REFERENCE TO RELATED APPLICATION

This application claims the benefit of and priority to Korean Patent Application No. 10-2024-0150078, filed in the Korean Intellectual Property Office on Oct. 29, 2024, the entire contents of which are incorporated herein by reference.

### TECHNICAL FIELD

The present disclosure relates to a method for preparing a platinum-based alloy catalyst.

### BACKGROUND

Platinum is evaluated as a material exhibiting excellent catalytic activity in various chemical reactions for automobile exhaust gas treatment, fuel cells, crude oil refining, organic compound synthesis, and hydrogen production due to its unique electronic structure characteristics. However, the high price of platinum is the biggest obstacle to the commercialization of the platinum-based catalyst, and various studies are actively being conducted to increase catalytic activity of platinum while minimizing a used amount of platinum.

As a way to reduce the used amount of platinum and increase the catalytic activity, there are attempts to reduce a size of platinum to the nanoscale to maximize an active area thereof that can participate in the reaction, or to increase the platinum dispersion by loading platinum particles on a porous support material, thereby increasing the active area. Furthermore, studies have been conducted to improve catalytic activity while relatively reducing the used amount of platinum by alloying platinum with an inexpensive metal material that has catalytic chemical synergy with platinum. In particular, it is known that the catalyst obtained by alloying platinum with other types of metals exhibits excellent catalytic performance for reforming reactions that prepare hydrogen from various hydrocarbons.

However, synthetic methods such as impregnation, precipitation, or ion exchange, which are used to prepare these platinum-based alloy catalysts, have the problems that it is not easy to form nano-sized catalyst particles, a size distribution of the catalyst particles is broad, and the catalyst production is complicated and takes a long time. Therefore, a new method that may replace the above preparation method is a solution combustion synthesis method.

The solution combustion synthesis method prepares the metal oxide powders by inducing a combustion reaction in a state where a metal salt is mixed with a reducing agent, and then reduces the powders to prepare the catalyst. In this regard, when two or more types of metals are used as the metal salt, the alloy catalyst can be prepared. When a precursor for a support is used together, a loaded catalyst can also be prepared. Since the combustion reaction is completed in a few seconds to a few minutes, the solution combustion synthesis method has the advantage of being able to quickly prepare the catalyst with a simple process, and has the advantage of being able to prepare a porous catalyst due to the rapid water eruption that occurs during the combustion process.

However, the solution combustion synthesis method is known to be unsuitable for preparing a platinum-based alloy catalyst. This is because during the high-temperature combustion reaction process, the platinum particles migrate and are buried inside a support, and the platinum particles distributed on the surface of the catalyst particles decrease, and as a result, the catalyst performance is insufficient compared to the used amount of platinum, or the used amount of platinum should be greatly increased to achieve sufficient performance.

The statements in this Background section merely provide background information related to the present disclosure and may not constitute prior art.

### SUMMARY

In view of the foregoing, a new preparation method that may be applied to the preparation of the platinum-based alloy catalyst while maintaining the advantages of the solution combustion synthesis method as described above is required.

The present disclosure has been made to solve the above-mentioned problems occurring in the prior art while advantages achieved by the prior art are maintained intact.

An aspect of the present disclosure provides a method for preparing a platinum-based alloy catalyst that may solve the above problem.

More specifically, the present disclosure provides a method for preparing a platinum-based alloy catalyst in which the solution combustion synthesis method is performed in two steps to minimize the phenomenon of platinum being buried inside the support, thereby preparing a catalyst having excellent performance even with a small used amount of platinum.

The technical problems to be solved by the present disclosure are not limited to the aforementioned problems, and any other technical problems not mentioned herein should be more clearly understood from the following description by those having ordinary skill in the art to which the present disclosure pertains.

According to an aspect of the present disclosure, a method for preparing a platinum-based alloy catalyst includes: preparing a first precursor composition containing a metal salt, a support salt, and a first reducing agent; combusting the first precursor composition to obtain first particles; preparing a second precursor composition containing the first particles, platinum salt, and a second reducing agent; combusting the second precursor composition to obtain second particles; and reducing the second particles.

According to an embodiment of the present disclosure, the metal salt includes at least one of Nickel (Ni), Copper (Cu), Iron (Fe), Cobalt (Co), Molybdenum (Mo), Manganese (Mn), or Silver (Ag).

According to an embodiment of the present disclosure, the metal salt includes at least one of nitrogen oxide of the metal, sulfur oxide of the metal, hydrochloride of the metal, superoxide of the metal, ammonium oxide of the metal, halide of the metal, hydrate of the nitrogen oxide of the metal, hydrate of the sulfur oxide of the metal, hydrate of the hydrochloride of the metal, hydrate of the superoxide of the metal, hydrate of the ammonium oxide of the metal, or hydrate of the halide of the metal.

According to an embodiment of the present disclosure, the support salt includes at least one of a metal-based support or a carbon-based support.

According to an embodiment of the present disclosure, the first reducing agent includes at least one of urea, glycine, sucrose, glucose, citric acid, hydrazine monohydrate, carbohydrazide, oxalyldihydrazide, hexamethylenetetramine, or acetylacetone.

According to an embodiment of the present disclosure, the second reducing agent includes at least one of urea, glycine, sucrose, glucose, citric acid, hydrazine monohydrate, carbohydrazide, oxalyldihydrazide, hexamethylenetetramine, or acetylacetone.

According to an embodiment of the present disclosure, each of the first reducing agent and the second reducing agent is independently selected.

According to an embodiment of the present disclosure, a molar ratio between the metal salt in the first precursor composition and the first reducing agent in the first precursor composition is in a range of 1:1.5 to 1:3.

According to an embodiment of the present disclosure, combusting the first precursor composition is initiated at a temperature in a range of 250° C. to 450° C.

According to an embodiment of the present disclosure, the platinum salt includes at least one of nitrogen oxide of platinum, sulfur oxide of the platinum, hydrochloride of the platinum, superoxide of the platinum, ammonium oxide of the platinum, halide of the platinum, hydrate of the nitrogen oxide of the platinum, hydrate of the sulfur oxide of the platinum, hydrate of the hydrochloride of the platinum, hydrate of the superoxide of the platinum, hydrate of the ammonium oxide of the platinum, or hydrate of the halide of the platinum.

According to an embodiment of the present disclosure, a molar ratio between the platinum salt in the second precursor composition and the second reducing agent in the second precursor composition is in a range of 1:20 to 1:40.

According to an embodiment of the present disclosure, a molar ratio between the metal salt in the first precursor composition and the platinum salt in the second precursor composition is in a range of 30:70 to 70:30.

(According to an embodiment of the present disclosure, combusting the second precursor composition is initiated at a temperature in a range of 250° C. to 450° C.

According to an aspect of the present disclosure, a method for preparing a platinum-based alloy catalyst includes: combusting a first precursor composition to obtain first particles, wherein the first precursor composition includes a metal salt, a support salt, and a first reducing agent; combusting a second precursor composition to obtain second particles, wherein the second precursor composition includes the first particles, platinum salt, and a second reducing agent; and reducing the second particles.

According to an embodiment of the present disclosure, the metal salt includes at least one of Nickel (Ni), Copper (Cu), Iron (Fe), Cobalt (Co), Molybdenum (Mo), Manganese (Mn), or Silver (Ag).

According to an embodiment of the present disclosure, the metal salt includes at least one nitrogen oxide of a metal, sulfur oxide of the metal, hydrochloride of the metal, superoxide of the metal, ammonium oxide of the metal, halide of the metal, hydrate of the nitrogen oxide of the metal, hydrate of the sulfur oxide of the metal, hydrate of the hydrochloride of the metal, hydrate of the superoxide of the metal, hydrate of the ammonium oxide of the metal, or hydrate of the halide of the metal.

According to an embodiment of the present disclosure, the support salt includes at least one of a metal-based support or a carbon-based support.

According to an embodiment of the present disclosure, the first reducing agent includes at least one of urea, glycine, sucrose, glucose, citric acid, hydrazine monohydrate, carbohydrazide, oxalyldihydrazide, hexamethylenetetramine, or acetylacetone, the second reducing agent includes at least one of urea, glycine, sucrose, glucose, citric acid, hydrazine monohydrate, carbohydrazide, oxalyldihydrazide, hexamethylenetetramine, or acetylacetone, and each of the first reducing agent and the second reducing agent is independently selected.

According to an embodiment of the present disclosure, a molar ratio between the metal salt in the first precursor composition and the first reducing agent in the first precursor composition is in a range of 1:1.5 to 1:3.

According to an embodiment of the present disclosure, combusting the first precursor composition is initiated at a temperature in a range of 250° C. to 450° C.

### BRIEF DESCRIPTION OF THE DRAWINGS

The above and other objects, features and advantages of the present disclosure should be more apparent from the following detailed description taken in conjunction with the accompanying drawings:

FIG. 1 is a diagram schematically showing a preparation process of a platinum-based alloy catalyst of the present disclosure;

FIG. 2 is a diagram showing XPS analysis results of a catalyst of Example 1 and a catalyst of Comparative Example;

FIG. 3A is an image of catalyst of Example 2 by using a HADDF-STEM;

FIG. 3B is an image showing the distribution of platinum in the image of FIG. 3A analyzed through an energy dispersive spectroscopy;

FIG. 3C is an image showing the distribution of nickel in the image of FIG. 3A analyzed through an energy dispersive spectroscopy;

FIG. 3D is an image showing the distribution of cerium in the image of FIG. 3A analyzed through an energy dispersive spectroscopy;

FIG. 3E is a graph showing the distribution of platinum and nickel confirmed through EDS line scanning in the area indicated by the dotted arrow in the image of FIG. 3A; and

FIG. 4 is a diagram comparing catalytic activity on a hydrazine decomposition reaction of the catalyst of Example 1 and the catalyst of Comparative Example with each other.

The drawings described herein are for illustration purposes only and are not intended to limit the scope of the present disclosure in any way.

### DETAILED DESCRIPTION

Hereinafter, the present disclosure is described in more detail.

Terms or words used in this specification and claims should not be interpreted as limited to their usual or dictionary meanings, and should be interpreted as meanings and concepts that comply with the technical ideas of the present disclosure based on the principle that the inventor may appropriately define the concept of the term. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

According to an embodiment of the present disclosure, a method for preparing a platinum-based alloy catalyst includes: a step (S1) of preparing a first precursor composition containing a metal salt, a support salt, and a first reducing agent; a step (S2) of first-combusting the first precursor composition to obtain first particles; a step (S3) of preparing a second precursor composition containing the first particles, a platinum salt, and a second reducing agent; a step (S4) of second-combusting the second precursor composition to obtain second particles; and a step (S5) of reducing the second particles.

The catalyst preparing method according to an embodiment of the present disclosure employs a solution combustion synthesis method, in which a metal capable of forming an alloy together with platinum is first loaded on a support, and then, platinum is second loaded on particles in which the metal is loaded on the support, thereby minimizing the phenomenon of platinum being buried inside the support, such that the platinum-based alloy catalyst capable of exhibiting excellent performance even with a small used amount of platinum may be prepared.

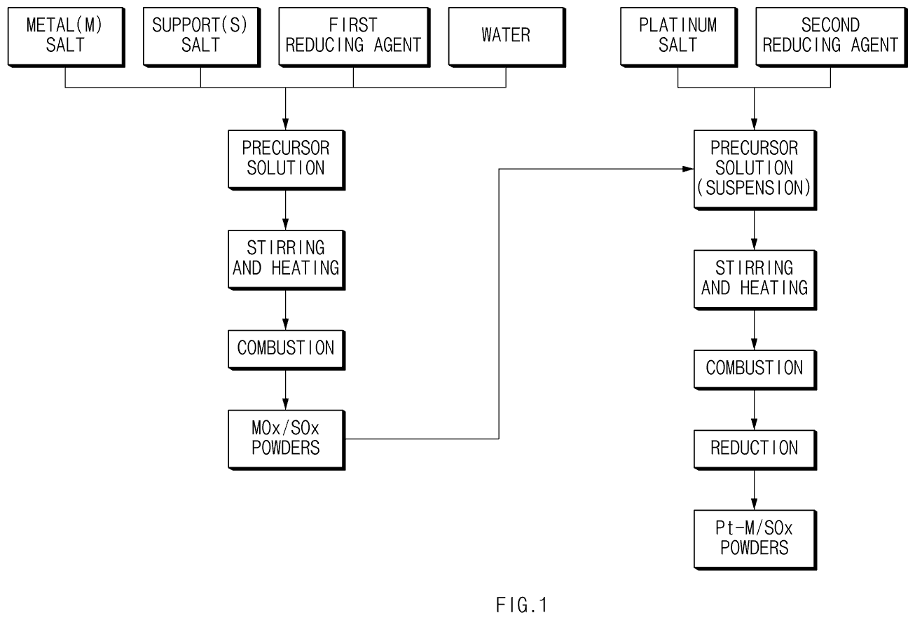

The catalyst preparing method according to an embodiment of the present disclosure can be illustrated by FIG. 1.

Hereinafter, the platinum-based alloy catalyst preparation method of the present disclosure is described step by step.

### S1 Step

First, a metal that forms an alloy together with platinum is loaded on a support. For this purpose, a step of preparing a first precursor composition containing a metal salt, a support salt, and a first reducing agent may be performed.

The metal salt is used as a raw material of a metal which forms an alloy together with platinum that is subsequently added. The metal salt may include at least one of Nickel (Ni), Copper (Cu), Iron (Fe), Cobalt (Co), Molybdenum (Mo), Manganese (Mn), or Silver (Ag). The metal salt may include one or more metals selected from the group consisting of Nickel (Ni), Copper (Cu), Iron (Fe), Cobalt (Co), Molybdenum (Mo), Manganese (Mn), and Silver (Ag). When each of the metals listed above forms an alloy together with platinum, the alloy exhibits excellent catalytic activity in various chemical reactions. Each of the metals listed above is able to reduce the cost of preparing the catalyst since the price of the metal itself is relatively low.

The metal salt should be easily soluble in a solvent of the first precursor composition. The metal salt may include at least one of nitrogen oxide of the metal, sulfur oxide of the metal, hydrochloride of the metal, superoxide of the metal, ammonium oxide of the metal, halide of the metal, hydrate of the nitrogen oxide of the metal, hydrate of the sulfur oxide of the metal, hydrate of the hydrochloride of the metal, hydrate of the superoxide of the metal, hydrate of the ammonium oxide of the metal, or hydrate of the halide of the metal. More specifically, the metal salt may be or include at least one selected from the group consisting of nitrogen oxide of the metal, sulfur oxide of the metal, hydrochloride of the metal, superoxide of the metal, ammonium oxide of the metal, halide of the metal, and hydrates thereof (e.g., hydrate of the nitrogen oxide of the metal, hydrate of the sulfur oxide of the metal, hydrate of the hydrochloride of the metal, hydrate of the superoxide of the metal, hydrate of the ammonium oxide of the metal, and hydrate of the halide of the metal).

In one example, the solvent of the first precursor composition may be or include water, a hydrocarbon solvent, or an alcohol solvent, The hydrocarbon solvent may be or include a solvent such as kerosene or benzene, and the alcohol solvent may be or include a solvent such as ethanol or methanol. The solvents listed above may be easily removed from the catalyst in a subsequent process while easily dissolving the metal salt and the support salt therein.

The support salt is a component that forms a support in a subsequent process, and the support may be or include a metal-based support or a carbon-based support. The metal-based support may be or include a metal such as cerium (Ce) or aluminum (Al), or an oxide thereof (e.g., an oxide of cerium, or an oxide of aluminum). The support salt may include at least one of nitrogen oxide of each of the support components, sulfur oxide of each of the support components, hydrochloride of each of the support components, superoxide of each of the support components, ammonium oxide of each of the support components, halide of each of the support components, or hydrate thereof (e.g., hydrate of nitrogen oxide of each of the support components, hydrate of sulfur oxide of each of the support components, hydrate of hydrochloride of each of the support components, hydrate of superoxide of each of the support components, hydrate of ammonium oxide of each of the support components, or hydrate of halide of each of the support components). The support salt may be or include at least one selected from the group consisting of nitrogen oxide, sulfur oxide, hydrochloride, superoxide, ammonium oxide, and halide of each of the support components, and hydrates thereof (e.g., hydrate of nitrogen oxide each of the support components, hydrate of sulfur oxide each of the support components, hydrate of hydrochloride each of the support components, hydrate of superoxide each of the support components, hydrate of ammonium oxide each of the support components, and hydrate of halide of each of the support components). The support salts listed above may form a porous support during the combustion process, and an inner space of the support may be filled with a metal oxide formed from the metal salt.

The first reducing agent may include at least one of urea, glycine, sucrose, glucose, citric acid, hydrazine monohydrate, carbohydrazide, oxalyldihydrazide, hexamethylene tetraamine, or acetylacetone. The first reducing agent may be or include at least one selected from the group consisting of urea, glycine, sucrose, glucose, citric acid, hydrazine monohydrate, carbohydrazide, oxalyldihydrazide, hexamethylene tetraamine, and acetylacetone. For example, the first reducing agent may be hydrazine monohydrate. The components are known as components that may be used as a reducing agent for a combustion reaction of the solution combustion synthesis method. In particular, when the first reducing agent components listed above are used, the activity of the catalyst as finally prepared may be more excellent.

A molar ratio between the metal salt and the first reducing agent in the first precursor composition may be in a range of 1:1.5 to 1:3. For example, a molar ratio between the metal salt and the first reducing agent in the first precursor composition may be 1:2 to 1:2.5. When the molar ratio between the metal salt and the first reducing agent is within the above-described range, a porosity and a surface area of the catalyst may be optimized, so that catalytic activity of the finally prepared catalyst may be considerably excellent.

### Step S2

The first precursor composition obtained through the above-described step S1 may be combusted such that the first particles in which the metal oxide is formed on the support may be obtained.

In this step, stirring of the first precursor composition may be performed together to obtain more uniform particles, and the first-combustion may be initiated at a temperature of 250 to 450° C., for example, 300 to 400° C. When the initiation temperature of the first-combustion is too low, the combustion reaction may not be sufficiently performed. However, when the initiation temperature is too high, excessive supplied energy may have a negative effect on the first particle. In one example, the initiation temperature of the first-combustion may be a preheating temperature of a furnace into which the first precursor composition is injected. The initiation temperature of the first-combustion may be controlled by controlling the preheating temperature of the furnace.

The first-combustion may be performed under an oxidizing atmosphere or an inert atmosphere, and the reaction may be completed within 10 minutes after the combustion reaction begins. When the first-combustion reaction begins, the temperature inside the furnace rapidly increases. The highest temperature inside the furnace during the first-combustion reaction may be in a range of 900 to 1300° C., for example, 1000 to 1200° C. After the combustion reaction ends, the temperature inside the furnace drops again to the initiation temperature of the combustion reaction.

### Step S3

The first particle formed through the step S2 has a form in which the oxide of the metal previously injected is filled into the support. Therefore, additionally loading platinum on the first particle may allow the phenomenon of platinum being buried inside the support to be suppressed. The loading of the platinum may also be performed through a solution combustion synthesis method. For this purpose, the present step of preparing the second precursor composition containing the first particles, the platinum salt, and the second reducing agent may be performed.

The platinum salt may include at least one of nitrogen oxide of the platinum, sulfur oxide of the platinum, hydrochloride of the platinum, superoxide of the platinum, ammonium oxide of the platinum, halide of the platinum, hydrate of the nitrogen oxide of the platinum, hydrate of the sulfur oxide of the platinum, hydrate of the hydrochloride of the platinum, hydrate of the superoxide of the platinum, hydrate of the ammonium oxide of the platinum, or hydrate of the halide of the platinum. In a similar manner to the metal salt, the platinum salt may be or include at least one selected from the group consisting of nitrogen oxide of the platinum, sulfur oxide of the platinum, hydrochloride of the platinum, superoxide of the platinum, ammonium oxide of the platinum, halide of the platinum, and hydrates thereof (e.g., hydrate of the nitrogen oxide of the platinum, hydrate of the sulfur oxide of the platinum, hydrate of the hydrochloride of the platinum, hydrate of the superoxide of the platinum, hydrate of the ammonium oxide of the platinum, and hydrate of the halide of the platinum).

The second reducing agent may include at least one of urea, glycine, sucrose, glucose, citric acid, hydrazine monohydrate, carbohydrazide, oxalyldihydrazide, hexamethylenetetramine, or acetylacetone. In a similar manner to the first reducing agent contained in the first precursor composition, the second reducing agent may be or include at least one selected from the group consisting of urea, glycine, sucrose, glucose, citric acid, hydrazine monohydrate, carbohydrazide, oxalyldihydrazide, hexamethylenetetramine, and acetylacetone. For example, the second reducing agent may be oxalyldihydrazide. A different agent from the first reducing agent described above may be used as the second reducing agent. In particular, hydrazine monohydrate may be used as the first reducing agent, and oxalyldihydrazide may be used as the second reducing agent. When the above components are respectively used as the first reducing agent and the second reducing agent, the activity of the catalyst as finally obtained may be improved.

The descriptions about the solvent of the first precursor composition may be equally applied to the descriptions about the solvent of the second precursor composition.

The molar ratio between the platinum salt and the second reducing agent in the second precursor composition may be in a range of 1:20 to 1:40. An amount of the second reducing agent used in the second precursor composition is larger than an amount of the first reducing agent used in the first precursor composition. In this way, the amount of the reducing agent contained in the second precursor composition may be controlled, such that the porosity and the surface area of the catalyst as finally obtained have desirable values, so that the catalytic activity may be considerably improved.

In one example, the molar ratio between the metal salt in the first precursor composition and the platinum salt in the second precursor composition may be in a range of 30:70 to 70:30. When the metal and platinum are contained at the above ratio range, the synergy effect between the two components may be maximized.

### S4 Step

In a similar manner to the S2 step, the second precursor composition obtained through the S3 step is combusted to obtain second particles in which an oxide of the alloy of the platinum and the metal are loaded on the support.

In this step, stirring of the second precursor composition may also be performed together to obtain more uniform particles. The second-combustion may also be initiated at a temperature of 250 to 450° C., for example, 300 to 400° C. When the initiation temperature of the second-combustion is too low, the combustion reaction may not be sufficiently performed. However, when the initiation temperature is too high, problems such as thermal decomposition of the obtained second particles may occur. In one example, the initiation temperature of the second-combustion may be a preheating temperature of the furnace into which the second precursor composition is introduced. The initiation temperature of the second-combustion may be controlled by controlling the preheating temperature of the furnace.

The second-combustion may be performed under an oxidizing atmosphere or an inert atmosphere, and the reaction may be completed within 10 minutes after the combustion reaction begins. When the second-combustion reaction begins, the temperature inside the furnace rapidly increases. The highest temperature inside the furnace during the second-combustion reaction may be in a range of 400 to 700° C., for example, 450 to 600° C. After the combustion reaction has been completed, the temperature inside the furnace drops again to the initiation temperature of the combustion reaction.

### S5 Step

The second particle obtained through the previous step is in a state where the oxide of the platinum alloy is loaded on the support. The oxide of the platinum alloy is reduced, such that a platinum-based alloy catalyst in which the platinum alloy itself is loaded on the support may be obtained.

The reduction may be performed via heat treatment in an atmosphere in which hydrogen gas exists at a certain content or higher. The atmosphere may be an atmosphere in which the content of hydrogen gas is equal to or greater than 5% by volume. For example, the atmosphere may be an atmosphere in which the content of hydrogen gas is equal to or greater than 10% by volume. The heat treatment may be performed at a temperature of equal to or higher than 300° C. and equal to or lower than 500° C.

Hereinafter, the present disclosure is described in more detail based on Examples. However, the following Examples are intended to exemplify the present disclosure and the scope of the present disclosure is not limited to these Examples.

### Example 1

Nickel(II) nitrate hexahydrate (Ni(NO₃)₂·6H₂O) and cerium ammonium nitrate ((NH₄)₂Ce(NO₃)₆) were dissolved in distilled water at a molar ratio of 3:97 to prepare an aqueous solution. Hydrazine hydrate (N₂H₄·H₂O) as the first reducing agent for the combustion reaction was added to the aqueous solution. The first precursor composition in which a molar ratio of nickel (II) nitrate hexahydrate and hydrazine hydrate was 1:2 was prepared.

The first precursor composition was placed in a furnace preheated to 350° C. and stirred. The first precursor composition spontaneously initiated the first-combustion reaction in the furnace, and the reaction was completed after 10 minutes to obtain the first particles (NiO/CeO₂) in which the nickel oxide was loaded on the cerium oxide support.

Separately from the first particles, an aqueous solution was prepared by mixing chloroplatinic acid hexahydrate (H₂PtCl₆·6H₂O) and oxalyldihydrazide as the second reducing agent with each other at a molar ratio of 1:30. The first particles were added to the prepared aqueous solution to prepare the second precursor composition. In one example, the molar ratio between nickel(II) nitrate hexahydrate used in the first precursor composition and the chloroplatinic acid hexahydrate was set to 45:55.

The second precursor composition was put into a furnace preheated to 350° C. and stirred. The second precursor composition spontaneously initiated the second-combustion reaction in the furnace, and the reaction was completed after 10 minutes to obtain the second particles (NiOPtO/CeO₂) in which a nickel platinum composite oxide was loaded on the cerium oxide support.

The obtained second particles were reduced in a 400° C. furnace in which 10 vol % hydrogen and 90 vol % helium gas flowed for 1 hour to finally obtain a catalyst.

### Example 2

A catalyst was obtained by performing the same procedure as in Example 1 except that the molar ratio between nickel(II) nitrate hexahydrate used in the first precursor composition and the chloroplatinic acid hexahydrate was set to 60:40.

### Comparative Example

Nickel(II) nitrate hexahydrate (Ni(NO₃)₂·6H₂O), cerium ammonium nitrate ((NH₄)₂Ce(NO₃)₆) and chloroplatinic acid hexahydrate (H₂PtCl₆·6H₂O) were dissolved in distilled water at a molar ratio of 2.9:96.8:0.3 to prepare an aqueous solution. Thereafter, oxalyldihydrazide as a reducing agent was added to the aqueous solution. In this regard, the molar ratio of the reducing agent and the metal precursor was 30:1.

The aqueous solution was put into a furnace preheated to 350° C. and stirred. The aqueous solution spontaneously initiated a combustion reaction in the furnace, and after 10 minutes, the reaction was completed, and the thus obtained nanoparticles were reduced for 1 hour in a heating furnace at 400° C. in which 10 vol % hydrogen and 90 vol % helium gas flowed, to finally obtain a catalyst.

### Experimental Example 1. Identification of Platinum Distribution on Surface of Catalyst Particles

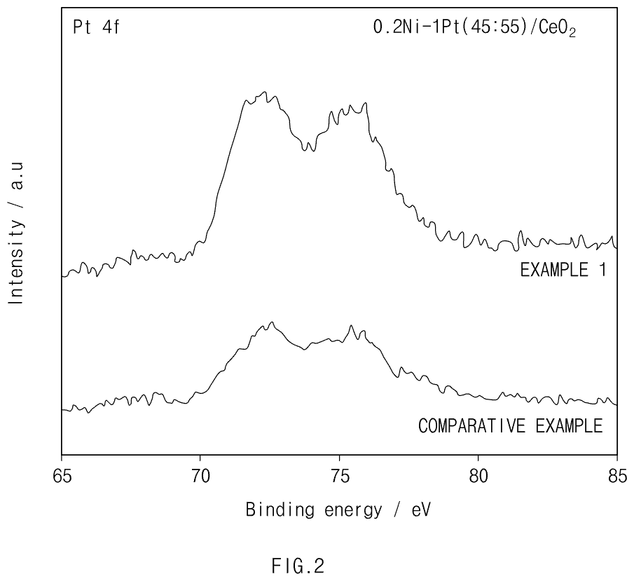

The amount of platinum present on the surface of the catalyst prepared in each of Example 1 and Comparative Example was identified through X-ray photoelectron spectroscopy (XPS) analysis. The XPS analysis equipment as used was Axis Ultra DLD from Kratos Analytical, and the analysis results are shown in FIG. 2.

The peaks in the binding energy regions of 72.5 eV and 76 eV correspond to the unique characteristics of platinum. A height of each of the corresponding peaks indicates the amount of platinum on the surface. Considering the results of FIG. 2, it may be identified that a greater amount of platinum exists on the surface of the catalyst prepared in Example 1.

Furthermore, an area size of the peak related to platinum identified in the XPS analysis results indicates the amount of platinum on the surface. The area size of the peak measured with a platinum standard sample of a known amount was compared with the area size of the peak measured in each of Example or Comparative Example to quantitatively analyze the amount of platinum present on the surface of each catalyst. As a result, it was identified that the amount of platinum present on the surface of the catalyst was 1.5 at % in Example 1 and 0.37 at % in Comparative Example. Considering that the amount of platinum used in the preparation was 0.88 at %, it may be identified that a significant portion of the platinum is present on the surface in the catalyst of the Example, while a significant portion of the platinum is buried inside the catalyst particles in the catalyst of Comparative Example.

From this fact, it was identified that using the catalyst preparation method of the present disclosure, even when the same amount of platinum was used, the amount of platinum distributed on the surface was increased to realize excellent catalytic activity.

### Experimental Example 2. Identification Whether Alloy Formation Occurs in Catalyst

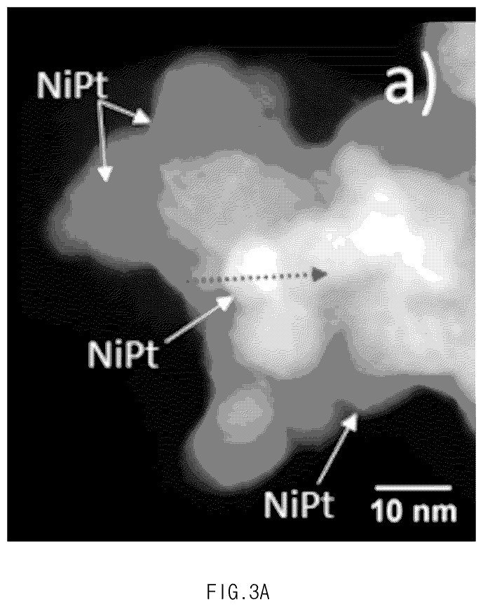

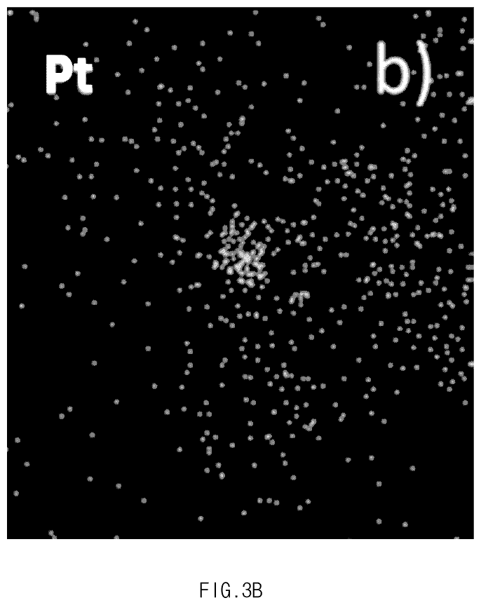

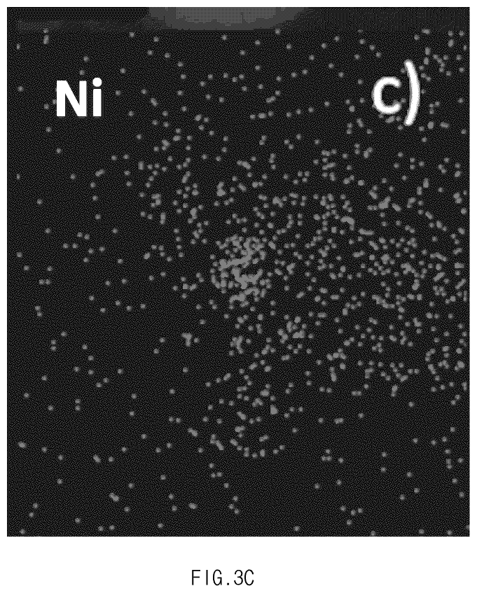

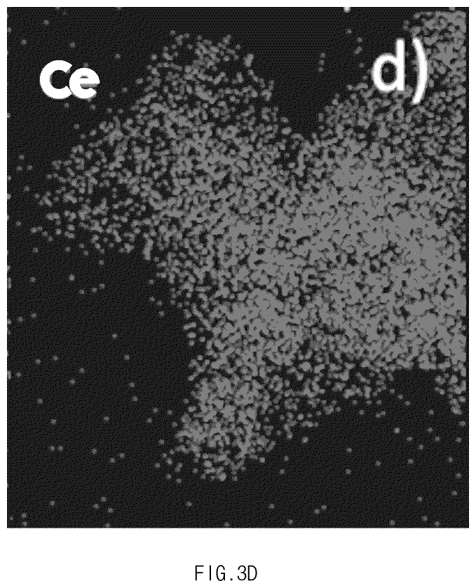

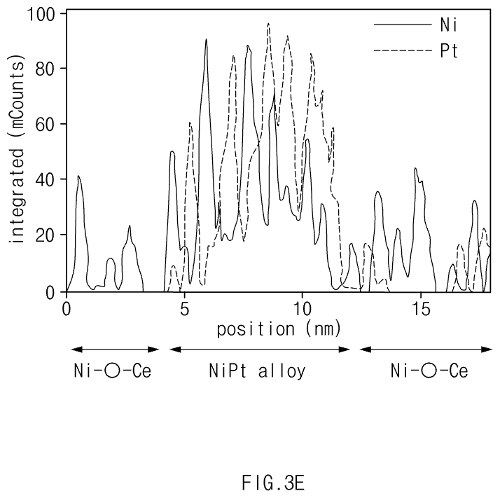

In the catalyst preparation process of Example 2, nickel was first loaded on the support, and then platinum was loaded thereon. It was identified whether an alloy of nickel and platinum was formed even when nickel and platinum were loaded separately thereon. More specifically, the prepared catalyst was analyzed on its components using high-angle annular dark-field imaging-scanning transmission electron microscope (HADDF-STEM) and energy-dispersive spectroscopy (EDS), and the results are shown in FIG. 3A to 3E.

Referring to FIGS. 3B, 3C, and 3D, it may be identified that platinum and nickel are evenly dispersed on the cerium oxide support. In addition, in FIG. 3A, the bright particles represent metal materials, and the relatively dark portion represents the cerium oxide support. From this fact, it may be identified that the size of the metal particles is approximately in a range of 1 to 8 nm. In particular, from the above result, it may be identified that Ni and Pt have similar dispersed patterns, and from this fact, it may be identified that the two metals have formed the alloy well.

In order to identify the above fact in more detail, the metal particles located in a center of FIG. 3A were subjected to line-scanning (EDS (Energy Dispersive Spectroscopy) line scanning), and the scanning result is shown in FIG. 3E. An area indicated by a line of NiPt alloy in FIG. 3E refers to an area indicated by a dotted arrow in FIG. 3A. The result of FIG. 3E indicates that nickel and platinum are located in the same space, which means that the two metals have formed the alloy. More specifically, EDS analysis in HADDF-STEM is an analysis method that may qualitatively identify which elements are distributed in a specific space. The result of FIG. 3E indicates that the peaks of nickel and platinum are distributed in a concentrated manner within the 8 nm metal particles, which means that the two metal elements are well mixed with each other at a nanoscale, thus indicating that the two metal elements have formed an alloy.

### Experimental Example 3. Comparison of Catalyst Activity

After performing a reaction using the catalyst of each of Example 1 and Comparative Example, the activities on the reaction thereof were compared with each other.

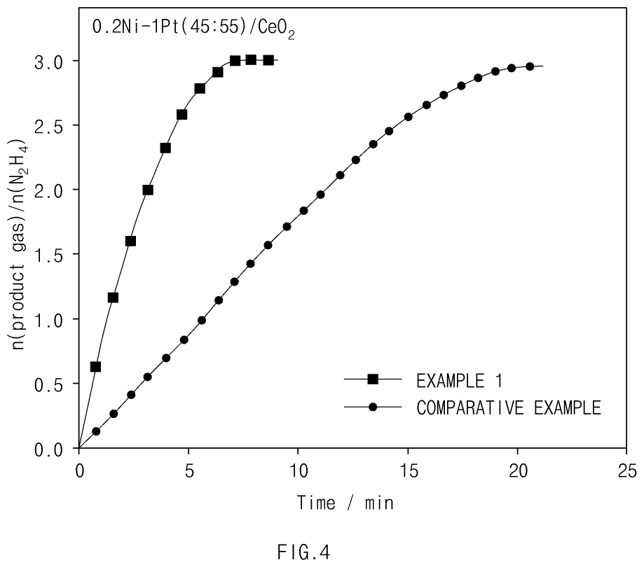

Specifically, a catalyst and a cocatalyst, i.e., 10 ml of a sodium hydroxide aqueous solution (0.5 M) were placed in a stainless steel reactor having a temperature which can be controlled using an external heating jacket, and argon was sufficiently injected into the reactor to remove the air inside the reactor while stirring the catalyst and the cocatalyst at 900 rpm so that the catalyst and the cocatalyst were well mixed with each other. Afterwards, while hydrazine hydrate as the reactant was introduced into the reactor so that the molar ratio between nickel and platinum as the reaction active material and the hydrazine hydrate was 0.17, the temperature inside the reactor was maintained at 50° C. to induce the decomposition reaction of hydrazine. The progress of the reaction was identified based on the pressure change inside the reactor. A time point at which there was no more pressure change inside the reactor was considered an end point of the reaction. Based on the end point, the composition of the generated gas was identified using a mass spectrometer to identify how well the decomposition reaction of hydrazine was performed. The result is shown in FIG. 4.

As may be identified from FIG. 4, the hydrazine decomposition reaction proceeded more quickly when the catalyst of Example 1 of the present disclosure was used. Specifically, using the catalyst of Example 1, it took about 7.5 minutes for the reaction to be completed. However, using the catalyst of Comparative Example, it took about 21 minutes. From this fact, it was identified that the catalyst of the present disclosure had superior catalytic activity due to the presence of a greater amount of platinum on the surface thereof.

In the preparation method of the present disclosure, a metal which forms an alloy together with platinum is first loaded on a support, and then, platinum is second loaded on the support while forming the alloy together with the metal, thereby minimizing the phenomenon of platinum being buried inside the support and maximizing the distribution of platinum on the surface of the support, thereby preparing a platinum-based alloy catalyst having excellent catalytic activity even with a small amount of platinum.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A method for preparing a platinum-based alloy catalyst, the method comprising:
preparing a first precursor composition containing a metal salt, a support salt, and a first reducing agent;
combusting the first precursor composition to obtain first particles;
preparing a second precursor composition containing the first particles, platinum salt, and a second reducing agent;
combusting the second precursor composition to obtain second particles; and
reducing the second particles.

2. The method of claim 1, wherein the metal salt includes at least one of Nickel (Ni), Copper (Cu), Iron (Fe), Cobalt (Co), Molybdenum (Mo), Manganese (Mn), or Silver (Ag).

3. The method of claim 1, wherein the metal salt includes at least one of nitrogen oxide of a metal, sulfur oxide of the metal, hydrochloride of the metal, superoxide of the metal, ammonium oxide of the metal, halide of the metal, hydrate of the nitrogen oxide of the metal, hydrate of the sulfur oxide of the metal, hydrate of the hydrochloride of the metal, hydrate of the superoxide of the metal, hydrate of the ammonium oxide of the metal, or hydrate of the halide of the metal.

4. The method of claim 1, wherein the support salt includes at least one of a metal-based support or a carbon-based support.

5. The method of claim 1, wherein the first reducing agent includes at least one of urea, glycine, sucrose, glucose, citric acid, hydrazine monohydrate, carbohydrazide, oxalyldihydrazide, hexamethylenetetramine, or acetylacetone.

6. The method of claim 1, wherein the second reducing agent includes at least one of urea, glycine, sucrose, glucose, citric acid, hydrazine monohydrate, carbohydrazide, oxalyldihydrazide, hexamethylenetetramine, or acetylacetone.

7. The method of claim 1, wherein each of the first reducing agent and the second reducing agent is independently selected.

8. The method of claim 1, wherein a molar ratio between the metal salt in the first precursor composition and the first reducing agent in the first precursor composition is in a range of 1:1.5 to 1:3.

9. The method of claim 1, wherein combusting the first precursor composition is initiated at a temperature in a range of 250° C. to 450° C.

10. The method of claim 1, wherein the platinum salt includes at least one of nitrogen oxide of platinum, sulfur oxide of the platinum, hydrochloride of the platinum, superoxide of the platinum, ammonium oxide of the platinum, halide of the platinum, hydrate of the nitrogen oxide of the platinum, hydrate of the sulfur oxide of the platinum, hydrate of the hydrochloride of the platinum, hydrate of the superoxide of the platinum, hydrate of the ammonium oxide of the platinum, or hydrate of the halide of the platinum.

11. The method of claim 1, wherein a molar ratio between the platinum salt in the second precursor composition and the second reducing agent in the second precursor composition is in a range of 1:20 to 1:40.

12. The method of claim 1, wherein a molar ratio between the metal salt in the first precursor composition and the platinum salt in the second precursor composition is in a range of 30:70 to 70:30.

13. The method of claim 1, wherein combusting the second precursor composition is initiated at a temperature in a range of 250° C. to 450° C.

14. A method for preparing a platinum-based alloy catalyst, the method comprising:
combusting a first precursor composition to obtain first particles, wherein the first precursor composition includes a metal salt, a support salt, and a first reducing agent;
combusting a second precursor composition to obtain second particles, wherein the second precursor composition includes the first particles, platinum salt, and a second reducing agent; and
reducing the second particles.

15. The method of claim 14, wherein the metal salt includes at least one of Nickel (Ni), Copper (Cu), Iron (Fe), Cobalt (Co), Molybdenum (Mo), Manganese (Mn), or Silver (Ag).

16. The method of claim 14, wherein the metal salt includes at least one nitrogen oxide of a metal, sulfur oxide of the metal, hydrochloride of the metal, superoxide of the metal, ammonium oxide of the metal, halide of the metal, hydrate of the nitrogen oxide of the metal, hydrate of the sulfur oxide of the metal, hydrate of the hydrochloride of the metal, hydrate of the superoxide of the metal, hydrate of the ammonium oxide of the metal, or hydrate of the halide of the metal.

17. The method of claim 14, wherein the support salt includes at least one of a metal-based support or a carbon-based support.

18. The method of claim 14, wherein:
the first reducing agent includes at least one of urea, glycine, sucrose, glucose, citric acid, hydrazine monohydrate, carbohydrazide, oxalyldihydrazide, hexamethylenetetramine, or acetylacetone;
the second reducing agent includes at least one of urea, glycine, sucrose, glucose, citric acid, hydrazine monohydrate, carbohydrazide, oxalyldihydrazide, hexamethylenetetramine, or acetylacetone; and
each of the first reducing agent and the second reducing agent is independently selected.

19. The method of claim 14, wherein a molar ratio between the metal salt in the first precursor composition and the first reducing agent in the first precursor composition is in a range of 1:1.5 to 1:3.

20. The method of claim 14, wherein combusting the first precursor composition is initiated at a temperature in a range of 250° C. to 450° C.
